(19) United States
(12) Patent Application Publication
(10) Pub. No.: US 2026/0365077 A1
(43) Pub. Date: Nov. 19, 2026

(54) BATTERY MANAGEMENT SYSTEM AND METHOD OF CONTROLLING THE SAME

(71) Applicants: HYUNDAI MOTOR COMPANY, SEOUL (KR); KIA CORPORATION, SEOUL (KR)

(72) Inventors: Hyun Jun Jang, Hwaseong-si (KR); Tae Kyu Kang, Hwaseong-si (KR); Si Joong Kim, Hwaseong-si (KR); Eun Hwan Kang, Hwaseong-si (KR); Hyun Jin Park, Hwaseong-si (KR); Rin Choi, Hwaseong-si (KR)

(73) Assignees: HYUNDAI MOTOR COMPANY, SEOUL (KR); KIA CORPORATION, SEOUL (KR)

(21) Appl. No.: 19/366,153

(22) Filed: Oct. 22, 2025

(30) Foreign Application Priority Data
May 13, 2025 (KR) 10-2025-0062092

(51) Int. Cl. B60L 58/15; B60L 58/14

(52) U.S. Cl. CPC B60L 58/15; B60L 58/14; B60L 2250/16; B60L 2260/42; B60L 2260/44

(57) ABSTRACT

A battery management system and a method of controlling the same for correcting errors in the state of charge (SOC) of a vehicle battery is provided. A method of controlling a battery according to an embodiment may include: determining, by a controller, at least one state of charge correction indicator based on cumulative usage history information of the battery; and outputting, by the controller, full charge warning information corresponding to the determined at least one state of charge correction indicator via a display or adjusting a predetermined charging limit of the battery.

### CROSS-REFERENCE TO RELATED APPLICATION

The present application claims priority to and the benefit of Korean Patent Application No. 10-2025-0062092 filed on May 13, 2025, the entire contents of which are incorporated herein for all purposes by this reference.

### BACKGROUND

### Technical Field

Various aspects of the present disclosure relate to a battery management system and a method of controlling the same for correcting errors in a state of charge (SOC) of a vehicle battery.

### Description of Related Art

In recent years, technical requirements for batteries, a key component of electric vehicles, have diversified. In particular, there is a growing interest in batteries that may satisfy safety, lifespan, and cost-effectiveness all together.

Among such batteries, some batteries have a 2-phase characteristic depending on the electrode material. The 2-phase characteristic here refers to a discharge curve that includes a flat range where the voltage remains constant during the discharge process of the battery, followed by a range where the voltage rapidly decreases. This characteristic arises from the coexistence of two different phases during the electrochemical reaction over a certain range, within which a phase transition occurs. A battery having such a characteristic may exhibit a flat voltage over a wide state of charge (SOC) range. A representative example of a battery having the 2-phase characteristic is a lithium iron phosphate (LFP) battery.

The LFP battery is being rapidly adopted as a battery for electric vehicles due to high thermal stability, long battery life, and economic advantages from not using expensive metals such as cobalt or nickel.

However, due to the aforementioned 2-phase characteristic, the LFP battery exhibits little variation in open-circuit voltage (OCV) across most of the SOC range. Therefore, there is a limitation in accurately estimating the SOC of the battery by using the voltage value alone. As a result, methods for estimating the SOC of the battery using complex estimation algorithms such as a coulomb counting method or Kalman filter have been provided. However, there are additional technical considerations such as initial state setting, cumulative error, and computational complexity.

Therefore, complementary techniques for improving SOC estimation accuracy have been provided to enhance the practical efficiency of batteries with the 2-phase characteristic.

The above description of the related art is intended to enhance understanding of the background of the present disclosure and should not be construed as an admission that such art is known to those having ordinary skill in the art.

### SUMMARY

Various aspects of the present disclosure are directed to providing a battery management system and a method of controlling the same for correcting errors in the state of charge (SOC) of a vehicle battery.

The technical object of various aspects of the present disclosure are not limited to the technical objects mentioned above, and other technical objects not mentioned should be clearly understood by those having ordinary skill in the art to which the present disclosure pertains from the following description.

A method of controlling a battery may be provided. The method may include determining, by a controller, at least one state of charge correction indicator based on cumulative usage history information of the battery. The method may also include outputting, by the controller, full charge warning information corresponding to the at least one determined state of charge correction indicator via a display or adjusting a predetermined charging limit of the battery.

In an embodiment, the method may further include referring, by the controller, to a state of charge of the battery to which an offset corresponding to the at least one determined state of charge correction indicator is applied in performing state-of-charge (SOC)-based control.

In an embodiment, the method may further include reducing, by the controller, a charge and discharge amount by a ratio corresponding to the at least one determined state of charge correction indicator in controlling charging and discharging of the battery based on a preset charge map or discharge map.

In an embodiment, the at least one state of charge correction indicator may include at least one of a cumulative usage capacity indicator, a cumulative driving distance indicator, or a cumulative driving time indicator of the battery.

In an embodiment, the outputting of the full charge warning information via the display by the controller may include outputting, by the controller, the full charge warning information corresponding to a level among the levels corresponding to each of the determined state of charge correction indicators via the display.

In an embodiment, the adjusting of the predetermined charging limit of the battery by the controller may include determining, by the controller, a predetermined charging limit of the battery to be 100% SOC based on one of the levels corresponding to each of the determined state of charge correction indicators meeting a preset criterion.

In an embodiment, the state of charge correction indicator may further include an indicator based on whether previous state of charge information of the battery is confirmed.

In an embodiment, the outputting of the full charge warning information via the display by the controller may include outputting, by the controller, the full charge warning information via the display until the state of charge of the battery reaches 100% based on an inability to confirm previous state of charge information of the battery.

In an embodiment, the outputting of the full charge warning information via the display by the controller may include determining, by the controller, the predetermined charging limit of the battery to be 100% SOC based on an inability to confirm previous state of charge information of the battery.

In an embodiment, the method may further include initializing, by the controller, a value of the at least one determined state of charge correction indicator based on the state of charge of the battery reaching 100%.

A battery management system may be provided. The battery management system may include a battery, a display, and a controller. The controller may be configured to determine at least one state of charge correction indicator based on cumulative usage history information of the battery, and output full charge warning information corresponding to the at least one determined state of charge correction indicator via the display or adjust the predetermined charging limit of the battery.

In an embodiment, the controller may be configured to refer to a state of charge of the battery to which an offset corresponding to the determined state of charge correction indicator is applied in performing state-of-charge (SOC)-based control.

In an embodiment, the controller may be configured to reduce a charge and discharge amount by a ratio corresponding to the at least one determined state of charge correction indicator in controlling charging and discharging of the battery based on a preset charge map or discharge map.

In an embodiment, the state of charge correction indicator may include at least one of a cumulative usage capacity indicator, a cumulative driving distance indicator, or a cumulative driving time indicator of the battery.

In an embodiment, the controller may be configured to output the full charge warning information corresponding to a level among the levels corresponding to each of the determined state of charge correction indicators via the display.

In an embodiment, the controller may be configured to determine the predetermined charging limit of the battery to be 100% SOC based on one of the levels corresponding to each of the determined state of charge correction indicators meeting a preset criterion.

In an embodiment, the state of charge correction indicator may further include an indicator based on whether previous state of charge information of the battery is confirmed.

In an embodiment, the controller may be configured to output the full charge warning information via the display until the state of charge of the battery reaches 100% based on an inability to confirm previous state of charge information of the battery.

In an embodiment, the controller may be configured to determine the predetermined charging limit of the battery to be 100% SOC based on an inability to confirm previous state of charge information of the battery.

In an embodiment, the controller may be configured to initialize a value of the at least one determined state of charge correction indicator based on the state of charge of the battery reaching 100%.

In an embodiment of the present disclosure, the controller may cause the battery to reach a fully charged state by determining whether to correct the state of charge (SOC) of the battery based on a state of charge correction indicator determined from the cumulative usage history information of the battery. In addition, by guiding the battery to a fully charged state, subsequent charge and discharge control may be performed more stably and precisely.

The effects that may be obtained by the embodiments of the present disclosure are not limited to those described above, and other effects that are not described should be apparent to those having ordinary skill in the art from the description below.

### BRIEF DESCRIPTION OF THE DRAWINGS

FIG. 1 shows a nonlinear relationship between a state of charge (SOC) of a battery and an open circuit voltage (OCV) according to an embodiment of the present disclosure.

FIG. 2 is a block diagram showing an example of a battery management system configuration according to an embodiment of the present disclosure.

FIG. 3 schematically shows a procedure performed by a battery management system according to an embodiment of the present disclosure to cause a battery to reach a fully charged state.

FIG. 4 shows an example of a step in which a battery management system determines each state of charge correction indicator based on cumulative usage history information of a battery in an embodiment of the present disclosure.

FIG. 5 shows an example of a process in which a battery management system determines a highest level according to an embodiment of the present disclosure.

FIG. 6 shows an example of a process in which a battery management system according to an embodiment of the present disclosure outputs full charge warning information corresponding to the determined highest level, adjusts a predetermined charging limit of a battery, and changes a control criterion of a battery.

FIG. 7 shows in detail a procedure performed by a battery management system according to an embodiment of the present disclosure to cause a battery to reach a fully charged state.

FIGS. 8 to 10 show examples of how full charge warning information according to an embodiment of the present disclosure is output via a vehicle cluster.

FIG. 11 shows a state of charge and a predetermined charging limit of a vehicle battery output via a display according to an embodiment of the present disclosure.

FIG. 12 shows an example of how a predetermined charging limit of a vehicle battery, fixed at 100% state of charge (SOC), is output via a display according to an embodiment of the present disclosure.

It may be understood that the appended drawings are not necessarily drawn to scale, presenting a somewhat simplified representation of various features illustrative of the basic principles of the present disclosure. The predetermined design features of the present disclosure as included herein, including, for example, specific dimensions, orientations, locations, and shapes are determined in part by the particularly intended application and use environment.

In the figures, reference numbers refer to the same or equivalent portions of the present disclosure throughout the several figures of the drawing.

### DETAILED DESCRIPTION

The various structural or functional descriptions of the embodiments disclosed in the present disclosure are provided merely to illustrate the embodiments, and the disclosed embodiments are not limited thereto but may be implemented in various forms.

The embodiments according to the present disclosure may be subject to various modifications and take various forms. Therefore, various embodiments are illustrated in the drawings and described in detail below. However, this is not intended to limit the disclosed embodiments to any particular form, but should be understood to include all modifications, equivalents, or substitutes that fall within the spirit and scope of the present disclosure.

Unless otherwise defined, all terms used herein, including technical and scientific terms, shall have the same meaning as commonly understood by those having ordinary skill in the art. Terms that are defined in commonly used dictionaries should be interpreted as having meanings consistent with their meanings in the context of the relevant technology and shall not be interpreted in an idealized or overly formal sense unless explicitly defined otherwise in the present disclosure.

Hereinafter, with reference to the accompanying drawings, embodiments of the present disclosure are described in detail. However, identical or similar components are assigned the same reference numerals regardless of the drawing numbers, and redundant descriptions thereof have been omitted.

In the description of the following embodiments, the term “preset” means that the numerical value of a parameter is determined in advance when the parameter is used in a process or algorithm. The numerical value of the parameter may be set when the process or algorithm is started or while the process or algorithm is being performed, depending on the embodiment.

As used in the description below, suffixes “module” and “part” for a component are used or interchangeably used solely for ease of preparation of the specification, and do not have different meanings and each of them does not function by itself.

In describing the disclosed embodiments, detailed descriptions of the known related art may be omitted if such descriptions are determined to obscure the gist of the disclosed embodiments. In addition, the accompanying drawings are provided solely to facilitate an understanding of the disclosed embodiments and do not limit the technical spirit of the present disclosure. It should be understood that all modifications, equivalents, and substitutes falling within the spirit and scope of the present disclosure are included.

Terms including ordinal numbers such as first, second, and the like used herein may be used to describe various components, but the components are not limited by these terms. The terms are used only for the purpose of distinguishing one component from another component.

When a component is referred to as being “connected” or “coupled” to another component, the component may be directly connected or coupled to another component, but it should be understood that another component may be present between the component and another component. Conversely, when a component is referred to as being “directly connected” or “directly coupled” to another component, it should be understood that another component may not be present between the component and another component.

Unless the context clearly dictates otherwise, the singular form includes the plural form.

In the present disclosure, the terms “comprising,” “having,” or the like are used to specify that a feature, a number, a step, an operation, a component, an element, or a combination thereof described herein exists, and do not preclude the possibility of the presence or addition of one or more other features, numbers, steps, operations, components, elements, or combinations thereof.

In addition, a unit or control unit included in names such as a motor control unit (MCU) and a hybrid control unit (HCU) is only a term widely used in the naming of a controller that controls the various functions of a vehicle, but does not mean a generic function unit.

A controller may include a communication device for communicating with other control units or sensors to control a responsible function, memory for storing an operating system, a logic command, and input/output information, and one or more processors for performing determination, calculation, and decision which are desired for controlling the responsible function.

When a controller, component, device, element, part, unit, module, or the like of the present disclosure is described as having a purpose or performing an operating, function, or the like, the controller, component, device, element, part, unit, or module should be considered herein as being “configured to” meet that purpose or perform that operating or function. Each controller, component, device, element, part, unit, module, and the like may separately embody or be included with a processor and a memory, such as a non-transitory computer-readable media, as part of the apparatus.

The embodiments of the present disclosure provide a method for more accurately estimating a state of charge (SOC) of a battery having a 2-phase characteristic. Hereinafter, the battery having a 2-phase characteristic is assumed to be a lithium iron phosphate (LFP) battery. However, this is for convenience of description, and the method may be applied to any battery with any electrode material as long as the battery has a 2-phase characteristic.

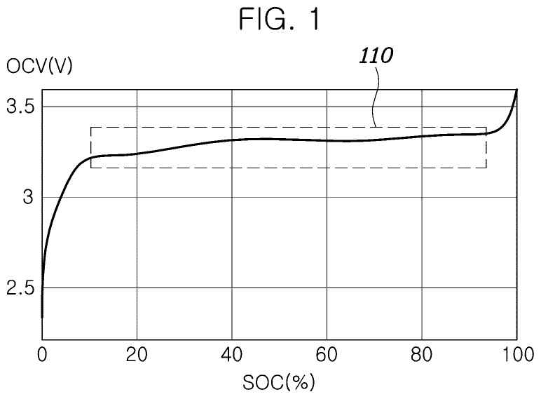

FIG. 1 shows a nonlinear relationship between the SOC of a battery and an open circuit voltage (OCV) according to an embodiment of the present disclosure.

Referring to FIG. 1, it may be seen that an LFP battery maintains a generally flat voltage within SOC range 110 between 10% and 90%. As such, if the voltage changes little over a wide SOC range, it may be difficult to accurately estimate the SOC of the battery using voltage values alone.

As described above, if it is difficult to accurately estimate the SOC of the battery, errors may occur in the estimated SOC, which may lead to inaccurate charge and discharge control by a battery management system (BMS), potentially degrading the performance of the battery. For example, if the battery management system incorrectly recognizes the SOC of the battery as higher than the actual value, the system may mistakenly assume that the battery has sufficient remaining capacity, which may ultimately lead to over discharge of the battery. Conversely, if the battery management system incorrectly recognizes the SOC of the battery as lower than the actual value, the system may prematurely stop discharging the battery despite sufficient remaining battery energy, which may result in underutilization of the available battery energy and reduced battery usage efficiency. Accordingly, the battery management device applicable in the embodiments of the present disclosure may provide a foundation for the battery management system to more accurately control the battery by guiding the battery to a fully charged state through a state of charge correction indicator determined based on cumulative usage history information of the battery.

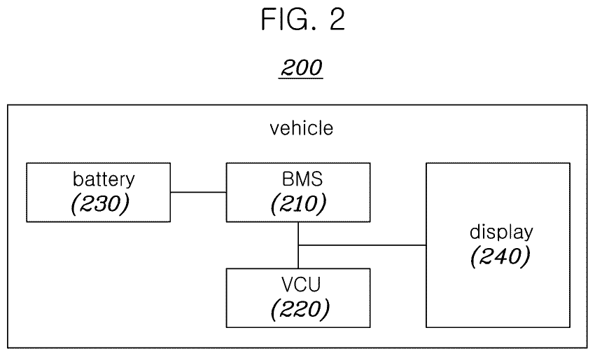

FIG. 2 is a block diagram showing an example of a battery management system configuration according to an embodiment of the present disclosure.

Referring to FIG. 2, a vehicle 200 according to an embodiment of the present disclosure may include a battery management system (BMS) 210, a vehicle control unit (VCU) 220, a battery 230, and a display 240. Each component is described in more detail below.

First, the battery management system 210 may collect and analyze state information of the battery 230 in real time to ensure efficient operation of the battery 230 and stable long-term operation of the battery 230. Specifically, the battery management system 210 may accurately confirm the current operating conditions of the battery 230 by continuously monitoring key state variables such as voltage, current, and temperature of the battery 230. Based on this, the battery management system 210 may control the charging and discharging of the battery 230 to prevent overcharging or over discharging during the charging and discharging processes of the battery 230. In an embodiment of the present disclosure, the battery management system 210 may determine at least one state of charge correction indicator based on cumulative usage history information of the battery 230. The state of charge correction indicator, determined as described above, may serve as a criterion for the battery management system 210 to output full charge warning information via the display 240 or to adjust a predetermined (e.g., desired) charging limit of the battery 230. In an embodiment of the present disclosure, the predetermined charging limit of the battery 230 may initially be set by the vehicle 200 manufacturer or the battery management system 210. The predetermined charging limit of the battery 230 may also be set by a driver via AVNT(Audio/Video/Navigation/Telematics) terminal (not show) or mobile terminal (not shown). However, the way in which the predetermined charging limit is set is not limited to the above examples. The detailed state of charge correction indicator and the method by which the battery management system 210 outputs full charge warning information or adjusts the predetermined charging limit of the battery 230 based on this indicator is described in more detail below.

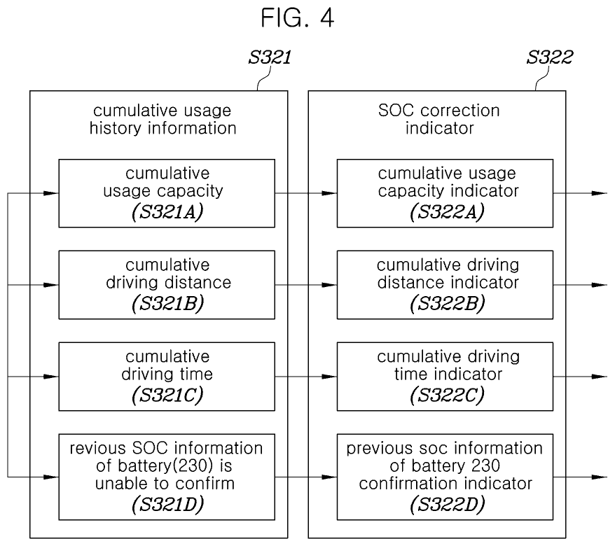

The vehicle control unit 220 may function as a higher-level control unit that comprehensively manages and controls a power electric (PE) system, which includes components such as a power conversion device (not shown), an electric motor (not shown), and the battery 230, including a drive system of an electrified vehicle. Through this, the vehicle control unit 220 may support efficient operation of the electrified vehicle and stable system performance by enabling integrated coordination among each component. In an embodiment of the present disclosure, the vehicle control unit 220 may precisely compute the cumulative driving distance and cumulative driving time based on the driving history of the vehicle 200 to provide highly reliable reference data useful for determining the aforementioned state of charge correction indicator. This is described in more detail with reference to FIG. 4.

The battery 230 may be a battery that includes an electrode material having a 2-phase characteristic. For example, in an embodiment of the present disclosure, the battery 230 is a lithium iron phosphate (LFP) battery, which improves thermal stability, battery lifespan, and output characteristics of the battery. However, as described above, the LFP battery may exhibit a flat voltage over a wide SOC range. Accordingly, if the battery management system 210, which measures the SOC of the battery 230 based on the voltage of the battery 230, performs charge and discharge control of the battery 230 based on the SOC of the battery 230, limitations may arise in the accuracy of charge and discharge control of the battery 230. Therefore, the battery management system 210 needs to provide a correction reference by guiding the SOC of the battery 230 to a fully charged state, so that the subsequent estimation of the SOC of the battery 230 may be performed more accurately. In an embodiment of the present disclosure, the battery management system 210 may prompt the driver to charge the battery 230 to a fully charged state by outputting full charge warning information via the display 240 or by adjusting the predetermined charging limit of the battery 230, so that the battery 230 may reach a fully charged state. This is described in more detail below.

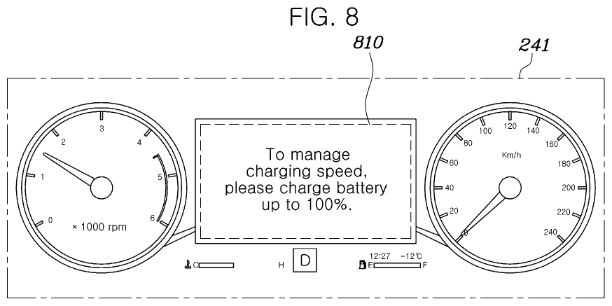

The display 240 may be used to provide the driver with information related to the vehicle 200 and may output such information based on data received from the battery management system 210 or the vehicle control unit 220. In general, the driver may intuitively recognize different types of information useful for the operation of the vehicle 200, such as the state of the battery 230, driving information of the vehicle 200, and warning messages, via the display 240. In an embodiment of the present disclosure, the display 240 may be a display of an AVNT (Audio, Video, Navigation and Telematics) terminal, a cluster, or a head-up display (HUD), but this is exemplary and is not limited thereto. The manner in which full charge warning information is output via the display 240, or in which the predetermined charging limit of the battery 230 is output, is described in more detail below with reference to FIGS. 8 to 12.

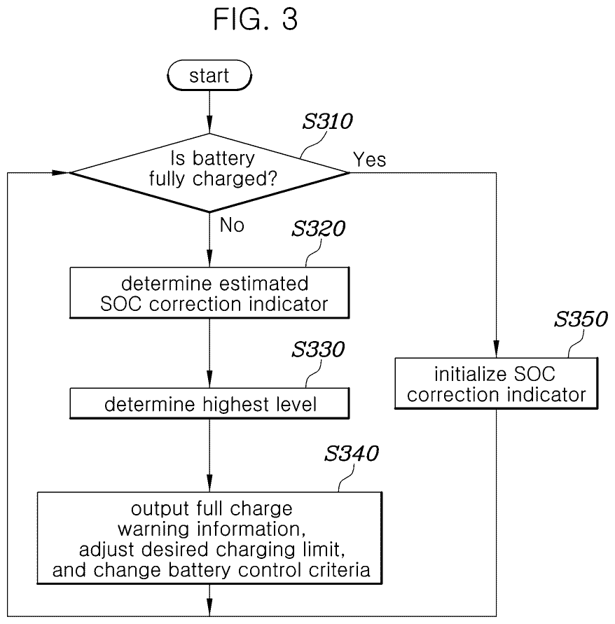

With reference to FIGS. 3 to 7, an example of a process in which the battery management system 210 controls the battery 230 to reach a fully charged state in order to improve the accuracy of SOC estimation of the battery 230 is described in detail below.

FIG. 3 schematically shows the overall flow of a procedure performed by the battery management system 210 according to an embodiment of the present disclosure to cause the battery 230 to reach a fully charged state.

Referring to FIG. 3, the battery management system 210 first determines whether the battery 230 is in a fully charged state (S310). If the battery 230 is not in a fully charged state (No in S310), the battery management system 210 may sequentially perform a total of three stepwise processes (S320, S330, and S340) to cause the battery 230 to reach a fully charged state.

The battery management system 210 may determine at least one state of charge correction indicator based on cumulative usage history information of the battery 230 (S320). The state of charge correction indicator may include at least one of the cumulative usage capacity indicator, the cumulative driving distance indicator, or the cumulative driving time indicator of the battery 230. To determine the above state of charge correction indicator, the battery management system 210 needs to compute the cumulative usage history information of the battery 230, which is described in more detail with reference to FIG. 4.

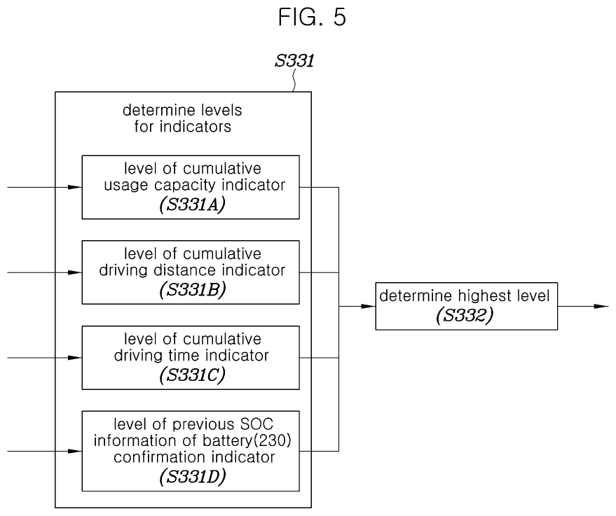

After the state of charge correction indicator is determined, the battery management system 210 may determine a level corresponding to each state of charge correction indicator and ultimately determine the highest level among the determined levels (S330). The criteria for determining the level corresponding to the state of charge correction indicator is described in detail below with reference to FIG. 5.

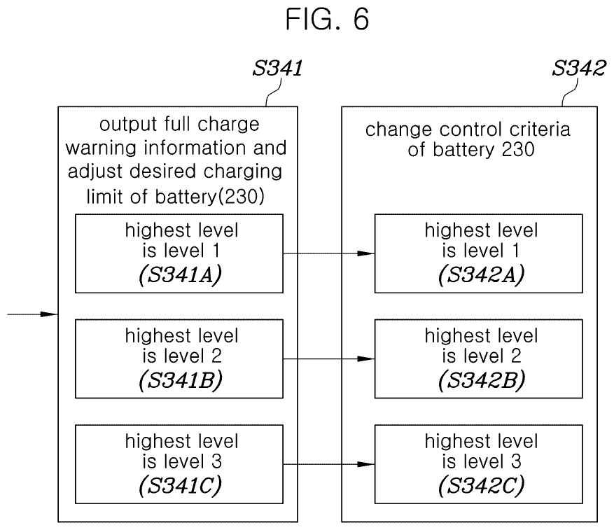

After determining the highest level as described above, the battery management system 210 may output full charge warning information corresponding to the determined highest level via the display 240, adjust the predetermined charging limit of the battery 230, or change the control criterion for the battery 230 based on the SOC of the battery 230 (S340). The full charge warning information, the predetermined charging limit of the battery, and the battery control criterion determined according to the level are described in detail below with reference to FIG. 6.

If the battery 230 is in a fully charged state (Yes in S310), the battery management system 210 may initialize the value of at least one determined state of charge correction indicator (S350). If the battery 230 is not in a fully charged state (No in S310), the battery management system 210 may refer to the corresponding state of charge correction indicator again to cause the battery 230 to reach a fully charged state.

FIG. 4 shows an example of a step in which the battery management system 210 determines each state of charge correction indicator based on cumulative usage history information of the battery 230 according to an embodiment of the present disclosure.

Each state of charge correction indicator may indicate an indicator that represents the extent of error in the estimated SOC values of the battery 230 or the degree of need for resetting the SOC of the battery 230 through full charging, determined based on the cumulative usage history information of different batteries 230. The cumulative usage history information of the battery 230, which serves as the criterion for determining each state of charge correction indicator, is introduced, followed by a detailed description of the process of obtaining each piece of introduced information (S321) and the process of determining the state of charge correction indicator based on the information (S322) in sequence below.

First, among the state of charge correction indicators, the cumulative usage capacity indicator of the battery 230 may be determined by the battery management system 210 based on the cumulative current amount or total energy consumption of the battery 230 (S322A). The process of obtaining the cumulative current amount or total energy consumption of the battery 230 (S321A) is described in more detail as follows.

In an embodiment of the present disclosure, the battery management system 210 may measure the current flowing through the battery 230 in real time via a current sensor (not shown) of the battery 230 and determine the usage capacity of the battery 230 by integrating the measured current value over time (S321A). The battery management system 210 may determine the cumulative usage capacity of the battery 230 using Equation 1 below.

∫|i|dt, [Equation 1]

In Equation 1, i is the current flowing through the battery 230 as measured by the current sensor. The reason for integrating the absolute value of the current over time is to more accurately compute the cumulative usage capacity of the battery 230 by considering not only the amount of discharge but also the amount of charge, such as charge accumulation in the battery 230 through regenerative braking during the driving of the vehicle 200.

In addition, the battery management system 210 may determine the cumulative energy consumption of the battery 230 using Equation 2 below and may replace the determined cumulative energy consumption of the battery 230 with the cumulative usage capacity of the battery 230.

∫|vi|dt, [Equation 2]

In equation 2, i is the current flowing through the battery 230 as measured by the current sensor, and v is the voltage of the battery 230. The reason for integrating the absolute value of the product of current and voltage over time is, similarly to Equation 1, to more accurately compute the cumulative usage capacity of the battery 230 by considering not only the amount of discharge but also the amount of charge.

The battery management system 210 may compute the cumulative usage capacity of the battery 230 as described above (S321A) and may determine the cumulative usage capacity indicator based on the computed cumulative usage capacity (S322A). For example, in an embodiment of the present disclosure, the battery management system 210 may control the cumulative usage capacity indicator to increase by 1 when the cumulative usage capacity of the battery 230 meets a value obtained by multiplying twice the rated capacity of the battery 230 by the state of health (SOH) of the battery 230. Similarly, when determining the cumulative energy consumption of the battery 230 using the above-described Equation 2, the battery management system 210 may control the cumulative usage capacity indicator to increase by 1 when the cumulative energy consumption meets a value obtained by multiplying twice the rated energy of the battery 230 by the state of health of the battery 230. However, the above-described method provided in relation to how the battery management system 210 determines the cumulative usage capacity indicator is exemplary and is not necessarily limited thereto.

The cumulative driving distance indicator may be determined based on the total distance driven by the vehicle 200 (S322B). The process of obtaining the total driving distance of the vehicle 200 (S321B) is described in more detail below.

The battery management system 210 may determine the energy consumption of the battery 230 using the above-described Equation 2, and based on the determined energy consumption and a preset energy consumption per unit distance, determine the cumulative driving distance of the vehicle 200 (S321B). However, the preset energy consumption per unit distance is set by each manufacturer based on the average energy consumption characteristics of the vehicle 200 and may not account for factors such as driving speed, acceleration or deceleration conditions of the vehicle 200, and the slope of the driving road. In other words, the cumulative driving distance of the vehicle 200 computed by the battery management system 210 based on the energy consumption of the battery 230 and the preset energy consumption per unit distance may not be accurate. In addition, the vehicle control unit 220 may compute the driving distance based on data obtained from a vehicle speed sensor (not shown), a wheel speed sensor (not shown), or a global positioning system (GPS) of the vehicle 200. Specifically, the vehicle control unit 220 may compute the driving distance of the vehicle 200 by multiplying the number of wheel rotations by the circumference value of the tire. However, this is exemplary and is not necessarily limited thereto. The driving distance of the vehicle 200 computed by the vehicle control unit 220 as described above may be more accurate since factors such as driving speed of the vehicle 200, acceleration and deceleration conditions, and the slope of the driving road are taken into consideration. Therefore, it may be more efficient for the battery management system 210 to receive driving distance information of the vehicle 200 from the vehicle control unit 220 and utilize this information, rather than computing the driving distance of the vehicle 200 using an internal system function.

The battery management system 210 may determine the cumulative driving distance indicator based on the driving distance of the vehicle 200 determined as described above (S322B). In an embodiment of the present disclosure, the battery management system 210 may control the cumulative driving distance indicator to increase by 1 when the driving distance of the vehicle 200 meets a value obtained by multiplying the estimated driving distance of the vehicle 200 by the state of health of the battery 230. The estimated driving distance of the vehicle 200 indicates the farthest distance that the vehicle 200 may drive when the battery 230 is in a fully charged state. The above-described method provided in relation to how the battery management system 210 determines the cumulative driving distance indicator is exemplary and is not necessarily limited thereto.

The cumulative driving time indicator may be determined based on the total driving time of the vehicle 200 using the battery 230 (S322C). The process of obtaining the driving time of the vehicle 200 (S321C) is described in more detail below.

The battery management system 210 may determine the energy consumption of the battery 230 using the above-described Equation 2, and based on the determined energy consumption and a preset average power consumption, determine the cumulative driving time of the vehicle 200 (S321C). However, the preset average power consumption is a value set by the manufacturer based on test data obtained during the development stage of the vehicle 200, and may differ from actual driving conditions of the vehicle 200, which may result in potential errors. Therefore, the cumulative driving time determined by the battery management system 210 based on the energy consumption of the battery 230 and the preset average power consumption may not be accurate. In addition, the vehicle control unit 220 may compute the time during which the vehicle 200 is operated and moved, based on information related to the driving of the vehicle 200, such as a vehicle speed sensor, a gear position sensor, and an ignition status signal provided in the vehicle 200. The driving time of the vehicle 200 computed by the vehicle control unit 220 as described above may be more accurate since the actual driving conditions of the vehicle 200 is taken into consideration. Therefore, it may be more efficient for the battery management system 210 to receive information on the driving time of the vehicle 200 from the vehicle control unit 220 and utilize this information, rather than computing the driving time of the vehicle 200 using an internal system function.

The battery management system 210 may determine the cumulative driving time indicator based on the driving time of the vehicle 200 determined as described above (S322C). In an embodiment of the present disclosure, the battery management system 210 may control the cumulative driving time indicator to increase by 1 when the driving time of the vehicle 200 reaches the equivalent of two weeks. However, the above-described method provided in relation to how the battery management system 210 determines the cumulative driving distance indicator is exemplary and is not necessarily limited thereto.

In addition, the state of charge correction indicator may further include an indicator based on whether previous state of charge information of the battery 230 may be confirmed. There may be various situations where previous state of charge information of the battery 230 may not be confirmed. For example, if the battery management system 210, responsible for overall management and control of the battery 230, is newly replaced or the software of the battery management system 210 is updated, previously stored data for managing the battery 230 may be initialized. However, this is exemplary and is not necessarily limited thereto.

If the previous state of charge information of the battery 230 may not be confirmed (S321D), the battery management system 210 may control a confirmation indicator of the previous state of charge information of the battery 230 to increase by 1 (S322D). However, if the previous state of charge information of the battery 230 may not be confirmed, there is no initial reference value for estimating the SOC of the battery 230, which places the battery management system 210 in an uncertain state in which accurate estimation of the SOC of the battery 230 is difficult. Accordingly, the battery management system 210 needs to actively cause the battery 230 to reach a fully charged state. If the battery management system 210 may not confirm the previous state of charge information of the battery 230 even once, the system may output full charge warning information via the display 240 until the SOC of the battery reaches 100%, or the predetermined charging limit of the battery 230 may be determined to be 100% SOC. This is described in detail below.

FIG. 5 shows an example of a process in which the battery management system 210 determines the highest level in an embodiment of the present disclosure.

Referring to FIG. 5, the process S330 of determining the highest level includes determining a level for each state of charge correction indicator (S331), and determining the highest level among the determined levels (S332).

First, the battery management system 210 may determine a level for each state of charge correction indicator (S331). The criteria by which the battery management system 210 determines the level for each indicator may vary. For example, in an embodiment of the present disclosure, if the cumulative usage capacity indicator exceeds 5 and is equal to or less than 8, the level may be 1, if the indicator exceeds 8 and is equal to or less than 9, the level may be 2, and if the indicator exceeds 9, the level may be 3 (S331A). If the cumulative driving distance indicator exceeds 4 and is equal to or less than 6, the level may be 1, if the indicator exceeds 6 and is equal to or less than 7, the level may be 2, and if the indicator exceeds 7, the level may be 3 (S331B). If the cumulative driving time indicator is 1, the level may be 1, if the indicator is 2, the level may be 2, and if the indicator is 3 or greater, the level may be 3. In addition, if the previous state of charge information of the battery 230 may not be confirmed, the uncertainty in estimating the SOC of the battery 230 is considered to be highest, so even if the indicator increases by 1, the level is 3. The criteria for classifying levels for each indicator as described above are exemplary and are not necessarily limited thereto.

The battery management system 210 may determine the highest level among the levels determined for each indicator (S332). As described above, since the criteria for determining levels for each indicator differ, the levels corresponding to each indicator may vary. For example, the level corresponding to the cumulative usage capacity indicator of the battery 230 may be 1, the level corresponding to the cumulative driving distance indicator may be 3, and the level corresponding to the cumulative driving time indicator may be 2. In this situation, the battery management system 210 may determine the highest level as 3.

FIG. 6 shows an example of a process in which the battery management system 210 according to an embodiment of the present disclosure outputs full charge warning information corresponding to the determined highest level, adjusts the predetermined charging limit of the battery 230, and changes the control criterion of the battery 230.

Referring to FIG. 6, after determining the highest level, the battery management system 210 may output full charge warning information corresponding to the highest level via the display 240 or adjust the predetermined charging limit of the battery 230 (S341). First, if the highest level determined by the battery management system 210 is 1, the battery management system 210 may output full charge warning information corresponding to level 1 via the display 240 for the first 5 seconds after the vehicle 200 starts (S341A). If the highest level is level 2, the battery management system 210 may output full charge warning information corresponding to level 2 via the display 240 for the first 10 seconds after the vehicle 200 starts, and may determine the predetermined charging limit of the battery 230 to be 100% (S341B). If the highest level is level 3, the battery management system 210 may output full charge warning information corresponding to level 3 via the display 240 until the battery 230 reaches a fully charged state, and may determine the predetermined charging limit of the battery 230 to be 100% (S341C). The meaning of full charge warning information corresponding to each level may be intensified as the level increases. This may be a measure intended to alert the driver to increased uncertainty in estimating the SOC of the battery 230. In addition, as the level increases, the duration for outputting full charge warning information corresponding to the level increases, which may be intended to indirectly prompt the driver to recognize the need to fully charge the battery 230. In addition, if the level is equal to or higher than a certain level, the predetermined charging limit of the battery 230 is fixed at 100%, which may be intended to cause the battery 230 to reach a full charge during charging. The criteria used to classify the levels, the full charge warning information output according to the level, and the adjusted predetermined charging limit of the battery 230 as described above are exemplary and are not necessarily limited thereto.

The battery management system 210 may subsequently change the control criteria for the battery 230 (S342). Specifically, when performing control based on the state of charge of the battery 230, the battery management system 210 may refer to the state of charge of the battery 230 to which an offset corresponding to the determined state of charge correction indicator is applied. In addition, when controlling the charging and discharging of the battery 230 based on a preset charging map or discharging map, the battery management system 210 may reduce the charge or discharge amount by a ratio corresponding to the state of charge correction indicator determined as described above. This may be a measure to prevent in advance issues such as battery life degradation or rapid performance degradation that may occur due to unstable control of the battery 230 caused by uncertainty in estimating the SOC of the battery. For example, if the SOC of the battery 230 measured by the battery management system 210 is lower than the actual SOC, the battery management system 210 controls the charging current or discharging current of the battery 230 based on the measured SOC. For example, during the charging process of the battery 230, a higher current than usual may be applied to compensate for an SOC that is lower than the actual value. Conversely, during the discharging process of the battery 230, the battery management system 210 may perform control so that a relatively lower current is output based on the determination that the SOC is insufficient. Such control may cause a reduction in battery life and performance degradation of the battery 230 because the control does not correspond to the actual state of the battery 230. Similarly, if the SOC measured by the battery management system 210 is higher than the actual SOC, the charging and discharging conditions of the battery 230 may be improperly set, which may lead to a reduction in battery life and performance degradation of the battery 230. Therefore, in the present disclosure, to prevent the reduction in battery life and performance degradation of the battery 230 caused by such errors, a more conservative control strategy may be applied. The battery management system 210 may refer to the SOC of the battery 230 to which an offset determined according to the level is applied, or control the charging and discharging of the battery 230 based on a preset charging map or discharging map according to a ratio determined by the level.

In an embodiment of the present disclosure, if the highest level is level 1, the battery management system 210 may refer to the SOC increased by 2% from the estimated SOC of the battery 230 and perform control to reduce the peak current applied during charging of the battery 230, or refer to the SOC decreased by 2% from the SOC of the battery 230 and perform control to reduce the peak output current during discharging of the battery 230 (S342A). In addition, if the highest level is level 1, the battery management system 210 may reduce the charging and discharging amount by 90% when controlling the charging and discharging of the battery 230 based on a preset charging map or discharging map (S342A). If the highest level is level 2, the battery management system 210 may refer to the state of charge of the battery 230 to which a 3% offset is applied and control the peak current applied during charging and output during discharging of the battery 230, and reduce the charging and discharging amount by 80% (S342B). If the highest level is level 3, the battery management system 210 may refer to the state of charge of the battery 230 to which a 5% offset is applied and control the peak current applied during charging and output during discharging of the battery 230, and reduce the charging and discharging amount by 70% (S342C). As described above, the criteria for controlling the battery 230 based on each level are merely examples for describing the concept of the present disclosure and are not necessarily limited thereto.

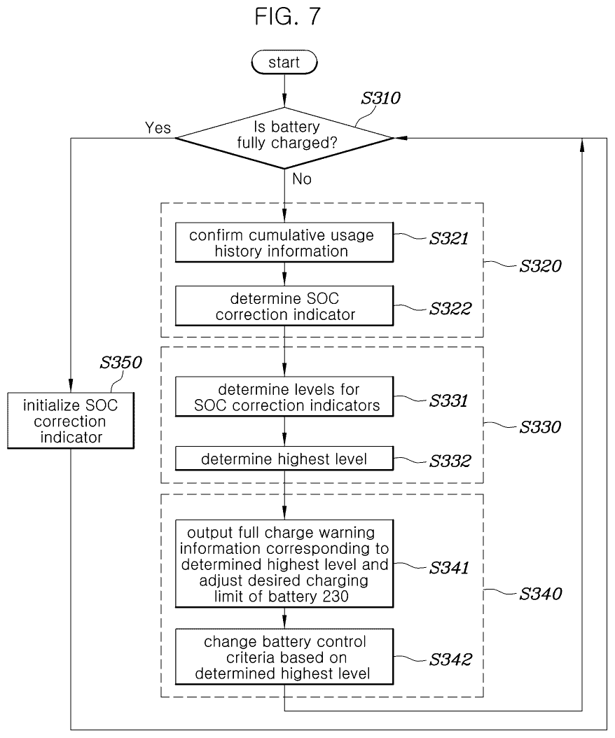

FIG. 7 shows in detail the overall flow of a procedure performed by the battery management system 210 according to an embodiment of the present disclosure to cause the battery 230 to reach a fully charged state.

Referring to FIG. 7, the battery management system 210 may determine whether the battery 230 is in a fully charged state (S310).

If the battery 230 is not in a fully charged state (No in S310), the battery management system 210 may determine a state of charge correction indicator for the battery 230 (S320). Specifically, the battery management system 210 may confirm the cumulative usage history information of the battery 230. In other word, in an embodiment of the present disclosure, the cumulative usage capacity of the battery 230, the driving distance of the vehicle 200, the driving time of the vehicle 200, or the confirmation status of the previous state of charge information of the battery 230 may be confirmed (S321). The battery management system 210 may determine a state of charge correction indicator based on the confirmed cumulative usage history information of the battery 230 (S322).

The battery management system 210 may determine the highest level among the levels corresponding to each determined state of charge correction indicator (S330). Specifically, the battery management system 210 may determine a level for each indicator based on different criteria (S331), and may determine the highest level among the determined levels (S332).

Subsequently, the battery management system 210 may perform a procedure to cause the battery 230 to reach a full charge corresponding to the determined highest level (S340). For example, the battery management system 210 may output full charge warning information corresponding to the highest level via the display 240, or may adjust the predetermined charging limit of the battery 230 (S341). In addition, the battery management system 210 may control the charge and discharge current of the battery 230 by referring to the SOC of the battery 230 to which an offset corresponding to the determined highest level is applied, and may also control the charging and discharging of the battery 230 according to the ratio corresponding to the highest level even when controlling charging and discharging of the battery 230 based on a preset charging map or discharging map (S342).

As described in FIG. 3, if the battery 230 is in a fully charged state (Yes in S310), the battery management system 210 may initialize the value of at least one determined state of charge correction indicator (S350).

If the battery management system 210 performs the procedure shown in FIG. 7, the system may more actively prompt the driver to charge the battery 230 to a fully charged state.

FIGS. 8 to 10 show examples of how full charge warning information according to an embodiment of the present disclosure is output via a cluster 241 of the vehicle 200. In FIGS. 8 to 10, it is assumed that, in an embodiment of the present disclosure, the battery management system 210 classifies the levels corresponding to each state of charge correction indicator determined based on the cumulative usage history information of the battery 230 into three levels.

FIG. 8 shows that the battery management system 210 outputs full charge warning information via the cluster 241 of the vehicle 200. The output full charge warning information corresponds to the lowest level of the three levels classified as described above. It may be seen that a relatively mild warning message 810 is displayed. This may indicate that the uncertainty in estimating the SOC of the battery 230 is relatively low.

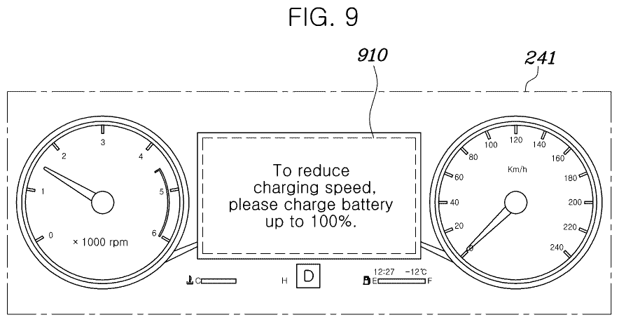

Referring to FIG. 9, as in FIG. 8, full charge warning information is output via the cluster 241. However, in contrast to FIG. 8, the full charge warning information shown in FIG. 9 corresponds to the intermediate level among the three levels classified as described above. As the level increases by one level, the full charge warning information is intensified. Accordingly, it may be seen that a changed message 910 indicates that ‘the charging speed of the battery 230 may decrease.’ This may indicate the intention of the battery management system 210 to perform stricter charging control on the battery 230 than before.

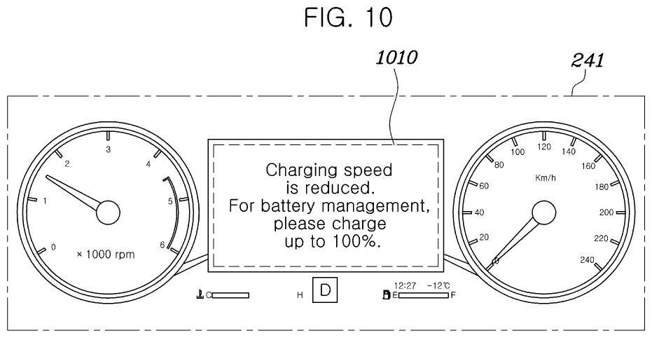

Referring to FIG. 10, as in FIG. 8, full charge warning information is output via the cluster 241. The full charge warning information shown in FIG. 10 corresponds to the highest level of the three levels classified as described above, and the warning message is also output at full intensity. Accordingly, it may be seen that an output message 1010 is changed to ‘The charging speed of the battery 230 is reduced.’ This may indicate the highest uncertainty in estimating the SOC of the battery 230, and may also signify that a stronger warning expression is used to more actively cause the battery 230 to reach a fully charged state.

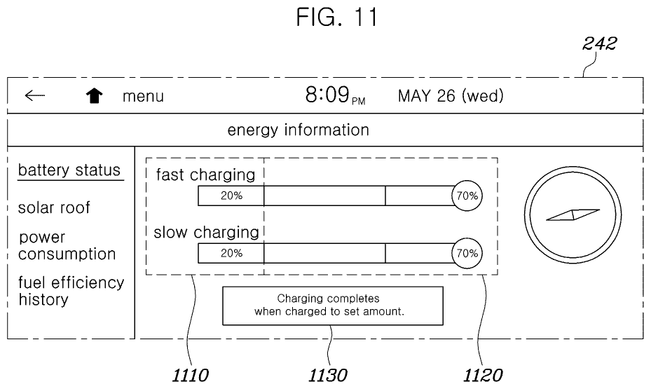

FIG. 11 shows a state of charge 1110 and a predetermined charging limit 1120 of the vehicle battery output via the display 242 of the AVNT terminal according to an embodiment of the present disclosure.

Referring to FIG. 11, it may be seen that the predetermined charging limit of the battery 230 is not determined to be 100% SOC by the battery management system 210 because the highest level among the levels corresponding to at least one state of charge correction indicator determined based on the cumulative usage history information of the battery 230 does not meet a preset criterion. In an embodiment of the present disclosure, the current state of charge 1110 of the battery 230 is 20%, and the predetermined charging limit 1120 set according to the driver's input is shown as 70%. In addition, a displayed guidance message 1130 provides instructions limited to charging up to the set predetermined charging limit 1120, rather than guiding the battery 230 to a fully charged state. This may indicate that the uncertainty in estimating the SOC of the battery 230 is relatively low.

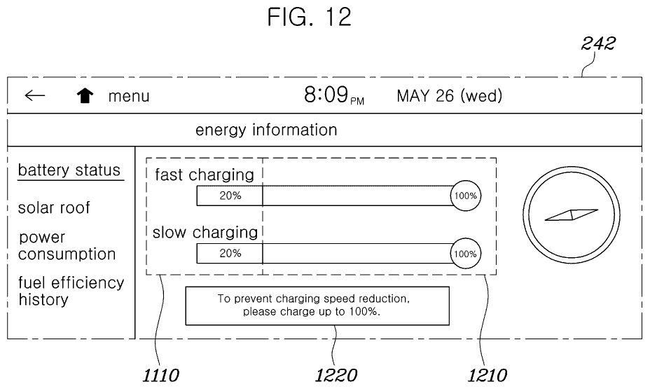

FIG. 12 shows an example of how the predetermined charging limit of a vehicle battery, fixed at 100% state of charge (SOC), is output via the display 242 of the AVNT terminal according to an embodiment of the present disclosure.

Referring to FIG. 12, it may be seen that the predetermined charging limit of the battery 230 is determined to be 100% SOC by the battery management system 210 because the highest level among the levels corresponding to at least one state of charge correction indicator determined based on the cumulative usage history information of the battery 230 meets a preset criterion. In an embodiment of the present disclosure, the current state of charge 1110 of the battery 230 is 20%, same as in FIG. 11, and the predetermined charging limit 1210 of the battery 230 is determined to be 100% SOC by the battery management system 210. In addition, a displayed guidance message 1220 is also changed and, in contrast to FIG. 11, the message is displayed to cause the battery 230 to reach a fully charged state. This may indicate the highest uncertainty in estimating the SOC of the battery 230, leading the battery management system 210 to perform more active control to cause the battery to reach a fully charged state.

As described above, although the spirit or technical scope intended to be provided by the present disclosure have been illustrated and described with reference to specific embodiments, it should be apparent to those having ordinary skill in the art that various modifications and changes may be made without departing from the technical spirit provided by the claims below.

What is claimed is:

1. A method of controlling a battery, the method comprising:
determining, by a controller, at least one state of charge correction indicator based on cumulative usage history information of the battery; and
outputting, by the controller, full charge warning information corresponding to the at least one determined state of charge correction indicator via a display or adjusting a predetermined charging limit of the battery.

2. The method of claim 1, further comprising:
referring, by the controller, to a state of charge of the battery to which an offset corresponding to the at least one determined state of charge correction indicator is applied in performing state-of-charge (SOC)-based control.

3. The method of claim 1, further comprising:
reducing, by the controller, a charge and discharge amount by a ratio corresponding to the at least one determined state of charge correction indicator in controlling charging and discharging of the battery based on a preset charge map or discharge map.

4. The method of claim 1, wherein the at least one state of charge correction indicator comprises at least one of a cumulative usage capacity indicator, a cumulative driving distance indicator, or a cumulative driving time indicator of the battery.

5. The method of claim 4, wherein the outputting of the full charge warning information via the display comprises outputting, by the controller, the full charge warning information corresponding to a level that meets a preset criterion among levels corresponding to each of the determined state of charge correction indicator via the display.

6. The method of claim 4, wherein the adjusting of the predetermined charging limit of the battery comprises determining, by the controller, the predetermined charging limit of the battery to be 100% SOC based on a level among levels corresponding to each of the determined state of charge correction indicators meeting a preset criterion.

7. The method of claim 4, wherein the state of charge correction indicator further comprises an indicator based on whether previous state of charge information of the battery is confirmed.

8. The method of claim 7, wherein the outputting of the full charge warning information via the display comprises outputting, by the controller, the full charge warning information via the display until the state of charge of the battery reaches 100% based on an inability to confirm previous state of charge information of the battery.

9. The method of claim 7, wherein the outputting of the full charge warning information via the display comprises determining, by the controller, the predetermined charging limit of the battery to be 100% SOC based on an inability to confirm previous state of charge information of the battery.

10. The method of claim 1, further comprising:
initializing, by the controller, a value of the at least one determined state of charge correction indicator based on the state of charge of the battery reaching 100%.

11. A battery management system comprising:
a battery;
a display; and
a controller configured to determine at least one state of charge correction indicator based on cumulative usage history information of the battery, and output full charge warning information corresponding to the at least one determined state of charge correction indicator via the display or adjust a predetermined charging limit of the battery.

12. The battery management system of claim 11, wherein the controller is configured to refer to a state of charge of the battery to which an offset corresponding to the at least one determined state of charge correction indicator is applied in performing state-of-charge (SOC)-based control.

13. The battery management system of claim 11, wherein the controller is configured to reduce a charge and discharge amount by a ratio corresponding to the at least one determined state of charge correction indicator in controlling charging and discharging of the battery based on a preset charge map or discharge map.

14. The battery management system of claim 11, wherein the state of charge correction indicator comprises at least one of a cumulative usage capacity indicator, a cumulative driving distance indicator, or a cumulative driving time indicator of the battery.

15. The battery management system of claim 14, wherein the controller is configured to output the full charge warning information corresponding to a level that meets a preset criterion among levels corresponding to each of the determined state of charge correction indicators via the display.

16. The battery management system of claim 14, wherein the controller is configured to determine the predetermined charging limit of the battery to be 100% SOC based on a level among levels corresponding to each of the determined state of charge correction indicators meeting a preset criterion.

17. The battery management system of claim 14, wherein the state of charge correction indicator further comprises an indicator based on whether previous state of charge information of the battery is confirmed.

18. The battery management system of claim 17, wherein the controller is configured to output the full charge warning information via the display until the state of charge of the battery reaches 100% based on an inability to confirm previous state of charge information of the battery.

19. The battery management system of claim 17, wherein the controller is configured to determine the predetermined charging limit of the battery to be 100% SOC based on an inability to confirm previous state of charge information of the battery.

20. The battery management system of claim 11, wherein the controller is configured to initialize a value of the at least one determined state of charge correction indicator based on the state of charge of the battery reaching 100%.
